(19) United States
(12) Patent Application Publication
(10) Pub. No.: US 2025/0167214 A1
(43) Pub. Date: May 22, 2025

(54) METHODS OF MANUFACTURING LITHIATED SILICON OXIDE-CONTAINING NEGATIVE ELECTRODES INCLUDING FUNCTIONAL POLYMERS AND BATTERIES THAT CYCLE LITHIUM IONS INCLUDING THE SAME

(71) Applicant: GM GLOBAL TECHNOLOGY OPERATIONS LLC, Detroit, MI (US)

(72) Inventors: Bradley R. FRIEBERG, Farmington Hills, MI (US); Roland J. KOESTNER, Webster, NY (US); Xiaosong HUANG, Novi, MI (US)

(21) Appl. No.: 18/514,194

(22) Filed: Nov. 20, 2023

(51) Int. Cl. H01M 4/36; H01M 4/02; H01M 4/04; H01M 4/38; H01M 4/58; H01M 4/583; H01M 4/62; H01M 10/052; H01M 10/0569

(52) U.S. Cl. CPC H01M 4/364; H01M 4/0404; H01M 4/382; H01M 4/58; H01M 4/583; H01M 4/622; H01M 4/625; H01M 10/052; H01M 10/0569; H01M 2004/027

(57) ABSTRACT

A battery that cycles lithium ions includes a negative electrode comprising an electroactive material comprising a lithiated silicon suboxide (LSO) material, a polymer binder, and a functional polymer. The negative electrode is manufactured from a precursor mixture including an electroactive material comprising a lithiated silicon suboxide (LSO) material, a polymer binder, a functional polymer, and an aqueous solvent. The LSO material includes a basic compound, and the functional polymer includes an acidic functional group formulated to react with the basic compound in the LSO material to neutralize the pH of the precursor mixture. The precursor mixture is deposited on a substrate to form a precursor layer, and then the aqueous solvent is removed from the precursor layer to form the negative electrode on the substrate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to methods of manufacturing electrodes of batteries that cycle lithium ions, and more particularly to methods of manufacturing negatives electrodes including silicon oxide-based electroactive materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit high ionic conductivity, good thermal stability, a wide electrochemical stability window, and the ability to form an ionically conductive solid electrolyte interphase (SEI) on surfaces of the negative and/or positive electrodes. The electrodes oftentimes have a composite structure comprising an electrochemically active (electroactive) material, an electrically conductive material, and a polymer binder. Silicon is a desirable electroactive material for the negative electrode due to its high theoretical specific capacity.

The composite electrodes may be manufactured by depositing a slurry comprising the electroactive material, the electrically conductive material, and the polymer binder in a solvent on substrate in the form of a continuous layer, followed by removal of the solvent. The polymer binder and the solvent are generally selected to avoid undesirable chemical reactions with the electroactive material and to ensure good solubility of the polymer binder in the solvent.

### SUMMARY

In a method of manufacturing a negative electrode for a battery that cycles lithium ions, in accordance with one or more embodiments of the present disclosure, a precursor mixture is deposited on a substrate to form a precursor layer. The precursor mixture comprises an electroactive negative electrode material comprising a lithiated silicon suboxide (LSO) material, a polymer binder, a functional polymer, and an aqueous solvent. The LSO material comprises a basic compound. The functional polymer comprises an acidic functional group formulated to react with the basic compound in the LSO material to neutralize the pH of the precursor mixture.

The aqueous solvent is removed from the precursor layer to form the negative electrode on the substrate.

In embodiments, the functional polymer may comprise a poly(carboxylic acid). In such case, the acidic functional group may comprise a carboxyl functional group (—C(═O)OH). For example, the functional polymer may comprise poly(acrylic acid).

In embodiments, the functional polymer may comprise a poly(sulfonic acid). In such case, the acidic functional group may comprise a sulfo functional group (—S(═O)₂—OH). For example, the functional polymer may comprise sulfonated poly(phenylene) (sPP), sulfo-phenylated poly(phenylene) (sPPP), or a combination thereof.

The functional polymer may be configured to react with lithium ions in the precursor mixture to form a lithium salt of the functional polymer.

In embodiments, the lithium salt of the functional polymer may be insoluble in the aqueous solvent, and wherein the lithium salt of the functional polymer may be configured to deposit on surfaces of the LSO material to form a physical barrier that prevents chemical reactions from occurring between the LSO material and the aqueous solvent.

The functional polymer may have a molecular weight of greater than or equal to about 10,000 grams per mole and less than or equal to about 400,000 grams per mole.

The LSO material may have a nanoporous structure including open nanopores, and wherein the functional polymer may be sized such that the functional polymer can infiltrate the open nanopores of the LSO material.

The polymer binder may comprise styrene butadiene rubber (SBR) and sodium carboxymethyl cellulose (Na-CMC).

The basic compound may comprise lithium hydroxide (LiOH), lithium carbonate (LiCO₃), or a combination thereof.

The electroactive negative electrode material may comprise the LSO material and graphite.

The precursor mixture may further comprise an electrochemically inactive, electrically conductive carbon-based material.

In embodiments, the method may further comprise preparing the precursor mixture by introducing the LSO material into a solution comprising the polymer binder, the functional polymer, and the aqueous solvent.

In other embodiments, the method may further comprise preparing the precursor mixture by preparing a first mixture comprising the LSO material and the functional polymer, preparing a second mixture comprising the polymer binder and the aqueous solvent, and then introducing the first mixture into the second mixture.

In a method of manufacturing a battery that cycles lithium ions, in accordance with one or more embodiments of the present disclosure, a precursor mixture is deposited on a negative electrode current collector to form a precursor layer. The precursor mixture comprises an electroactive negative electrode material comprising, a polymer binder, a functional polymer comprising a sulfonated poly(phenylene), and an aqueous solvent. The electroactive negative electrode material comprises a lithiated silicon suboxide (LSO) material and optionally graphite. The LSO material comprises a basic compound. The functional polymer comprises a sulfo functional group (—S(═O)₂—OH) formulated to react with the basic compound in the LSO material to neutralize the pH of the precursor mixture. The aqueous solvent is removed from the precursor layer to form a negative electrode on the negative electrode current collector. The negative electrode and the negative electrode current collector are assembled into a stack comprising a positive electrode disposed on a positive electrode current collector and a separator sandwiched between opposed facing surfaces of the negative electrode and the positive electrode. The positive electrode comprises lithium ions.

The functional polymer may comprise sulfo-phenylated poly(phenylene) (sPPP).

The functional polymer may be configured to react with lithium ions in the precursor mixture to form a lithium salt of the functional polymer.

In embodiments, the lithium salt of the functional polymer may be insoluble in the aqueous solvent. In such case, the lithium salt of the functional polymer may be configured to deposit on surfaces of the LSO material to form a physical barrier that prevents chemical reactions from occurring between the LSO material and the aqueous solvent.

The polymer binder may comprise styrene butadiene rubber (SBR) and sodium carboxymethyl cellulose (Na-CMC).

A battery that cycles lithium ions comprises a negative electrode, a positive electrode spaced apart from the negative electrode, and an electrolyte infiltrating the negative electrode and the positive electrode. The negative electrode comprises an electroactive material, a polymer binder, and a functional polymer comprising a lithium salt of a sulfonated poly(phenylene). The electroactive material comprises a lithiated silicon suboxide (LSO) material and optionally graphite. The positive electrode comprises an electroactive positive electrode material. The electrolyte comprises a lithium salt in a polar aprotic organic solvent.

The functional polymer may comprise a lithium salt of a phenylated sulfonated poly(phenylene). In embodiments, the functional polymer may be insoluble in water.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

In the drawings, reference numbers may be reused to identify similar and/or identical elements.

### DETAILED DESCRIPTION

The presently disclosed methods can be used to manufacture batteries that cycle lithium ions and that include negative electrodes comprising lithiated silicon suboxide (LSO) as an electroactive material. During manufacture of the LSO-containing negative electrodes, a precursor mixture comprising the LSO material and a functional polymer in an aqueous solvent is deposited on a metal substrate. The functional polymer is formulated to prevent or inhibit undesirable chemical reactions from occurring between the LSO material and the aqueous solvent during manufacture of the negative electrode. In addition, the functional polymer comprises acidic functional groups that can react with the basic compounds in the precursor mixture to help neutralize the pH of the precursor mixture, thereby improving adhesion of the negative electrode to the metal substrate.

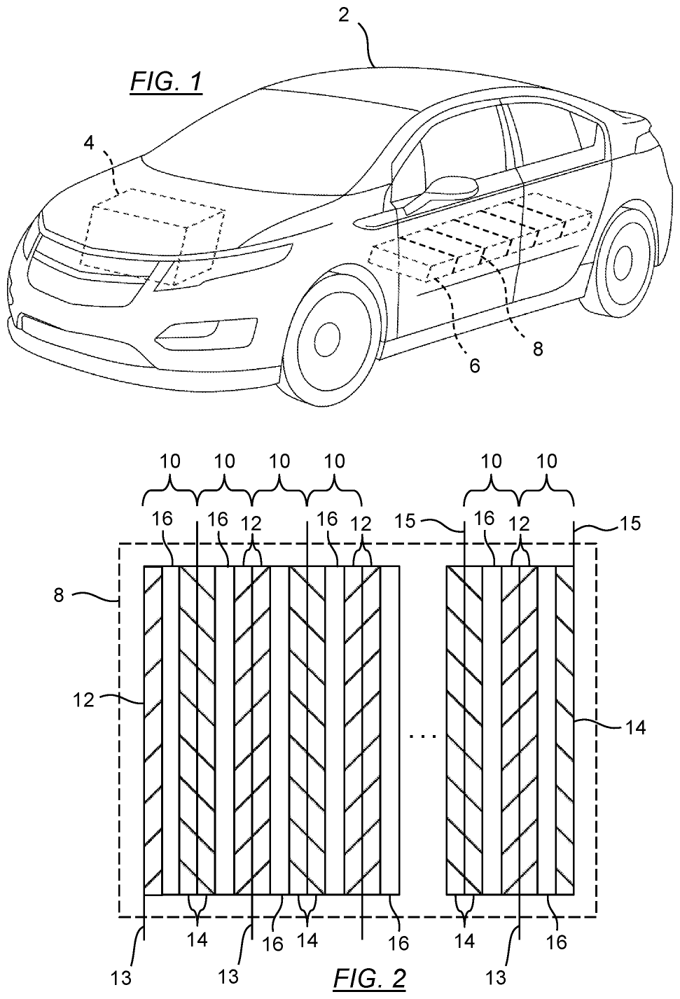

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

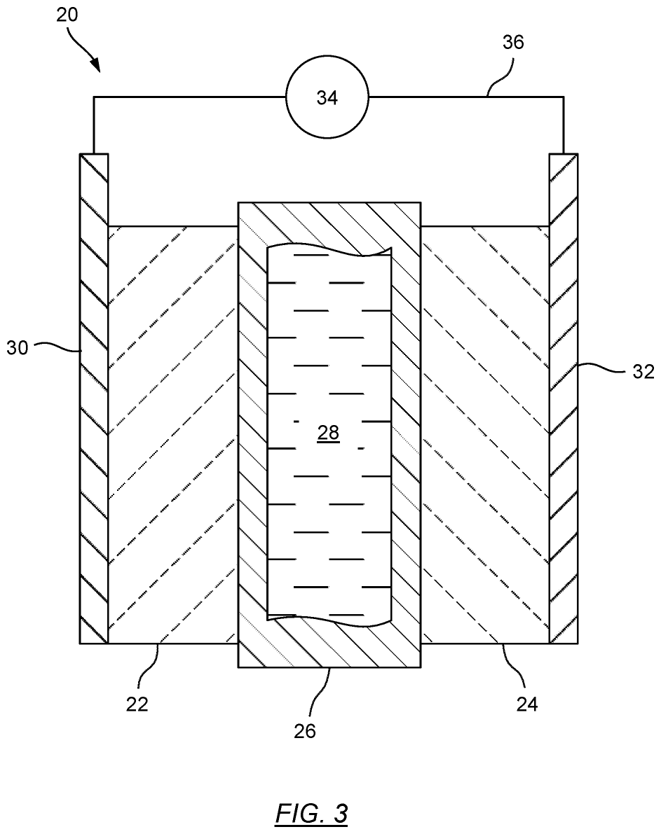

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is formulated to store and release lithium ions to facilitate charge and discharge, respectively, of the battery 20. The negative electrode 22 may be in the form of a continuous porous layer of material disposed on a major surface of the negative electrode current collector 30. The negative electrode 22 comprises an electrochemically active (electroactive) material, a polymer binder, a functional polymer, and optionally an electrically conductive material. The electroactive material of the negative electrode 22 may be referred to herein as an “electroactive negative electrode material.”

The electroactive material of the negative electrode 22 is formulated to store and release lithium ions by undergoing a reversible redox reaction with lithium during charge and discharge of the battery 20. The electroactive material may constitute, by weight, greater than or equal to about 80%, or optionally greater than or equal to about 90%, and less than or equal to about 97%, or optionally less than or equal to about 95% of the negative electrode 22.

The electroactive material of the negative electrode 22 comprises a lithiated silicon suboxide (LSO) material. Prior to initial charge of the battery 20, the LSO material may have the following chemical formula (1):

LiₓSiO_{y}, (1)

where 0<x≤2 and 0<y≤2.

As an electroactive material, silicon suboxide (SiOₓ, where 0<x≤2) can facilitate the storage of lithium in the negative electrode 22 during charge of the battery 20 by forming an alloy with lithium (lithiation) and, during discharge of the battery 20, lithium ions can be released therefrom by dealloying from the SiOₓ (delithiation). However, during initial charge of the battery 20, undesirable irreversible side reactions tend to occur between the lithium ions and the SiOₓ, resulting in the consumption of active lithium, irreversible capacity loss, and a low initial coulombic efficiency. Prelithiating SiOₓ to form the LSO material prior to incorporation in the negative electrode 22 has been found to reduce the occurrence of undesirable irreversible side reactions between lithium and SiOₓ during initial cycling of the battery 20, thereby improving the reversible capacity and cycling stability of the battery 20.

In embodiments, the LSO material may have an open nanoporous structure with open pores (nanopores) having diameters of greater than or equal to about 1 nanometer (nm) and less than or equal to about 100 nm. The LSO material may constitute, by weight, greater than or equal to about 10%, optionally greater than or equal to about 20%, optionally greater than or equal to about 30%, optionally greater than or equal to about 40%, optionally greater than or equal to about 50%, optionally greater than or equal to about 60%, optionally greater than or equal to about 70%, optionally greater than or equal to about 80%, optionally greater than or equal to about 90%, and less than or equal to about 100% of the electroactive material of the negative electrode 22.

In addition to the LSO material, the negative electrode 22 may comprise one or more other electroactive materials. Examples of other electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, tin oxide, aluminum, indium, zinc, germanium, titanium oxide, lithium titanate, and combinations thereof. In embodiments, the electroactive material of the negative electrode 22 may comprise a composite of the LSO material and graphite. For example, in embodiments, the electroactive material of the negative electrode 22 may consist of the LSO material and graphite.

The polymer binder is electrochemically inactive and is formulated to provide the negative electrode 22 with structural integrity and to help adhere the negative electrode 22 to the major surface of the negative electrode current collector 30. To facilitate manufacture of the negative electrode 22, the polymer binder may be water soluble. The polymer binder may comprise styrene butadiene rubber (SBR), carboxymethyl cellulose (CMC), sodium carboxymethyl cellulose (Na-CMC), sodium alginate, or a combination thereof. In aspects, the polymer binder may comprise a mixture of SBR and Na-CMC. The polymer binder may constitute, by weight, greater than or equal to about 2% and less than or equal to about 10% of the negative electrode 22.

The functional polymer is formulated to prevent or inhibit undesirable chemical reactions from occurring between the LSO material and the aqueous solvent included in the precursor mixture used to form the negative electrode 22, as discussed further below. In embodiments, the functional polymer may be insoluble in water. The term “functional polymer,” as used herein, refers to a polymer having functional groups (e.g., acidic functional groups) and/or a polymer that performs a specific function, i.e., that prevents or inhibits undesirable chemical reactions from occurring between the LSO material and the aqueous solvent included in the precursor mixture used to form the negative electrode 22. In embodiments, the functional polymer also may prevent or inhibit undesirable chemical reactions from occurring between the LSO material and the organic solvent included in the electrolyte 28 during operation of the battery 20.

The molecular weight of the functional polymer may be selected so that chains of the functional polymer are sufficiently small so as to be able to at least partially infiltrate the open nanopores of the LSO material and thereby comprehensively protect the LSO material from undesirable chemical reactions with the aqueous solvent and/or with the electrolyte 28. In embodiments, the functional polymer may have a molecular weight of greater than or equal to about 10,000 grams per mole (g/mol) and less than or equal to about 400,000 g/mol, optionally less than or equal to about 300,000 g/mol, optionally less than or equal to about 200,000 g/mol, optionally less than or equal to about 100,000 g/mol, or optionally less than or equal to about 50,000 g/mol.

The functional polymer may comprise an acid functional polymer having acidic functional groups, a lithium salt of an acid functional polymer, or a combination thereof. As used herein, a lithium salt of an acid functional polymer is an acid functional polymer in which at least 25 percent of the acidic functional groups have a lithium ion as a counterion, optionally at least 50 percent of the acidic functional groups have a lithium ion as a counterion, or optionally at least 50 percent of the acidic functional groups have a lithium ion as a counterion. In embodiments, the functional polymer may comprise poly(carboxylic acid), poly(sulfonic acid), a lithium salt of poly(carboxylic acid), a lithium salt of poly(sulfonic acid), or a combination thereof. Examples of poly(carboxylic acid)s include poly(acrylic acid) (PAA), poly(methacrylic acid) (PMAA), poly(maleic acid), poly(ethylacrylic acid) (PEAA), poly(propylacrylic acid) (PPAA), poly(4-vinylbenzoic acid) (PVBA), poly(itaconic acid) (PIA), and combinations thereof. Examples of poly(sulfonic acid)s include sulfonated aromatic polymers, poly(vinylsulfonic acid) (PVSA), poly(4-styrenesulfonic acid) (PSSA), poly(2-acrylamido-2-methylpropane sulfonic acid) (PAMPS), poly(3-sulfopropyl methacrylate) (PSPMA), and combinations thereof. In embodiments, the functional polymer may comprise poly(acrylic acid) (PAA), lithium poly(acrylate) (Li-PAA), sulfonated poly(phenylene) (sPP), sulfo-phenylated poly(phenylene) (sPPP), a lithium salt of sulfonated poly(phenylene) (Li-sPP), a lithium salt of sulfo-phenylated poly(phenylene) (Li-sPPP), or a combination thereof.

The amount of the functional polymer in the negative electrode 22 may be selected to correspond to the amount of the LSO material in the negative electrode 22. In embodiments, the functional polymer may constitute, by weight, greater than or equal to about 0.1% and less than or equal to about 5% of the negative electrode 22.

The electrically conductive material is optional and may be included in the negative electrode 22 to provide the negative electrode 22 with good electrical conductivity. Examples of electrically conductive materials include carbon-based materials, metals (e.g., nickel), and/or electrically conductive polymers. Examples of electrically conductive carbon-based materials include carbon black (CB) (e.g., acetylene black), graphene (e.g., graphene nanoplatelets, GNPs), graphene oxide, carbon nanotubes (CNTs) (e.g., single-walled CNTs and/or multi-walled CNTs), and/or carbon fibers (e.g., carbon nanofibers). Examples of electrically conductive polymers include polyaniline, polythiophene, polyacetylene, and/or polypyrrole. When present the electrically conductive material may constitute, by weight, greater than or equal to about 0.5% and less than or equal to about 10% of the negative electrode 22.

The negative electrode 22 may have a thickness of greater than or equal to about 30 micrometers (μm), optionally greater than or equal to about 50 μm, optionally greater than or equal to about 70 μm, or optionally greater than or equal to about 100 μm and less than or equal to about 500 μm.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electroactive material (electroactive positive electrode material), a polymer binder, and optionally an electrically conductive material.

The electroactive material of the positive electrode 24 can store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂, an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). Specific examples of lithium transition metal oxides include LiNi_{1-x-y}CoₓMn_{y}O₂ (NMC), where 0≤x≤1 and 0≤y≤1; LiNi_{1-x-y-z}CoₓMn_{y}Al_{z}O₂ (NCMA), where 0≤x≤1, 0≤y≤1, and 0≤z≤1; LiNi_{1-x-y}CoₓAl_{y}O₂ (NCA), where 0≤x≤1 and 0≤y≤1; LiNiₓMn₁₋ₓO₂ (LNMO), where 0≤x≤1; lithium manganese oxide (LMO) (e.g., Li₍₁₊ₓ₎Mn₂O₄, where 0.1≤x≤1); lithium nickel manganese oxide (LiNi_{0.5}Mn_{1.5}O₄); lithium cobalt oxide (LiCoO₂) (LCO); lithium iron phosphate (LiFePO₄); lithium vanadium phosphate (LiVPO₄); lithium manganese iron phosphate (LiMn₁₋ₓFeₓPO₄, where 0≤x≤1); lithium manganese rich layered oxide (LMR); and combinations thereof. In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide, selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt).

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders for the positive electrode 24 include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof.

The optional electrically conductive material is electrochemically inactive and may be included in the positive electrode 24 to provide the positive electrode 24 with sufficient electrical conductivity to support the percolation of electrons therethrough. Examples of electrically conductive materials for the positive electrode 24 include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers for the positive electrode 24 include include polyaniline, polythiophene, polyacetylene, and/or polypyrrole.

The separator 26 is configured to physically separate and electrically isolate the negative electrode 22 and the positive electrode 24 from each other while permitting lithium ions to pass therethrough. The separator 26 has an open microporous structure and may comprise an organic and/or inorganic material. For example, the separator 26 may comprise a polymer, e.g., a polyolefin. In embodiments, the separator 26 may comprise polyethylene (PE), polypropylene (PP), polyamide (PA), poly(tetrafluoroethylene) (PTFE), polyvinylidene fluoride (PVDF), and/or poly(vinyl chloride) (PVC).

The electrolyte 28 is ionically conductive and is formulated to provide a medium for the conduction of lithium ions between the negative electrode 22 and the positive electrode 24. The electrolyte 28 comprises an organic solvent and a lithium salt in the organic solvent. The organic solvent may comprise a nonaqueous polar aprotic organic solvent. Non-limiting examples of non-aqueous polar aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or 5-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium tetraphenylborate (LiB(C₆H₅)₄), lithium bis(oxalato)borate (LiB(C₂O₄)₂) (LiBOB), lithium difluoro(oxalato)borate (LiBF₂(C₂O₄)) (LiDFOB), and combinations thereof.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (AI) or another appropriate electrically conductive material.

### Methods

The negative electrode 22 may be manufactured by depositing a precursor mixture on a metal substrate to form a precursor layer, and then drying the precursor layer to form the negative electrode 22 on the metal substrate. In embodiments, the metal substrate may be made of substantially the same material as that of the negative electrode current collector 30.

The precursor mixture comprises the electroactive negative electrode material, the polymer binder, the functional polymer, and the optional electrically conductive material in an aqueous solvent, e.g., water. The electroactive negative electrode material, the polymer binder, the functional polymer, and the optional electrically conductive material may be present in the precursor mixture in substantially the same proportions as that in the negative electrode 22. The electroactive negative electrode material, the polymer binder, and the optional electrically conductive material included in the precursor mixture may have substantially the same composition as the electroactive negative electrode material, the polymer binder, and the optional electrically conductive material included in the negative electrode 22. In particular, the electroactive negative electrode material included in the precursor mixture may comprise the LSO material and optionally one or more other electroactive materials.

The precursor mixture may be prepared by mixing the electroactive negative electrode material, the polymer binder, the functional polymer, the aqueous solvent, and the optional electrically conductive material together. For example, in some embodiments, the precursor mixture may be prepared by introducing the LSO material into a solution comprising the polymer binder, the functional polymer, and the aqueous solvent. In other embodiments, the precursor mixture may be prepared by preparing a first mixture comprising the LSO material and the functional polymer, preparing a second mixture comprising the polymer binder and the aqueous solvent, and then introducing the first mixture into the second mixture. In any embodiment, the LSO material is preferably combined with one or more other components of the precursor mixture after such components are combined with the functional polymer, or at substantially the same time as such components are combined with the functional polymer.

As discussed above, the LSO material may be formed by prelithiating a silicon suboxide (SiOₓ) material prior to incorporating the LSO material into the negative electrode 22, which may help reduce the consumption of active lithium during initial cycling of the battery 20, as compared to the amount of active lithium that would otherwise be consumed during initial cycling if the SiOₓ was not prelithiated. However, it has been found that, when the LSO material is placed in contact with water in the aqueous solvent used to prepare the precursor mixture, undesirable chemical reactions may occur between the LSO material and the water. For example, when in contact with water, basic compounds (i.e., lithium salts including LiOH and/or LiCO₃) in the LSO material may dissolve and ionize in the aqueous solvent, releasing hydroxide (OH⁻) anions (and Li⁺ cations), which may undesirably increase the pH of the precursor mixture. At the same time, lithium (Li) and silicon (Si) in the LSO material may react with the water in the aqueous solvent to respectively form LiOH and SiO₂, with the concomitant generation of hydrogen (H₂) gas. The generation of H₂ gas during preparation of the precursor mixture may create a safety hazard and may undesirably result in the formation of bubbles and/or pits in the resulting negative electrode 22. In addition, formation of LiOH and/or SiO₂ from the LSO material may reduce the specific capacity of the negative electrode 22 and may further increase the pH of the precursor mixture. It has been found, however, that if the pH of the precursor mixture is too high (e.g., greater than or equal to about 12 or about 13), the negative electrode 22 may not adhere sufficiently to the surface of the metal substrate.

The functional polymer is formulated to react and/or interact with the LSO material to form a physical barrier on surfaces thereof that inhibits or prevents undesirable contact between the LSO material and the water in the aqueous solvent during manufacture of the negative electrode 22. For example, the functional polymer may create a physical barrier on surfaces of the LSO material that prevents the basic compounds (e.g., LiOH and/or LiCO₃) in the LSO material from reacting with and dissolving in the aqueous solvent, thereby preventing or inhibiting the LSO material from undesirably increasing the pH of the precursor mixture. As another example, the functional polymer may create a physical barrier on surfaces of the LSO material that prevents Li and/or Si in the LSO material from reacting with the water in the aqueous solvent and generating H₂ gas, thereby improving the homogeneity and processability of the precursor mixture.

The functional polymer used to prepare the precursor solution is an acid functional polymer and comprises acidic functional groups that are configured to react with the basic compounds (e.g., the OH⁻ anions) in the precursor mixture to neutralize the pH of the precursor mixture and thereby improve adhesion of the negative electrode 22 to the metal substrate. Examples of acidic functional groups include carboxyl groups (—C(═O)OH), sulfo groups (—S(═O)₂—OH), phosphono groups (—P(═O)(—OH)₂), nitro groups (—NO₂), mercapto groups (—SH), and combinations thereof. Examples of acid functional polymers include poly(carboxylic acid)s, poly(phosphonic acid)s, poly(sulfonic acid)s, poly(amino acid)s, poly(boronic acid)s, and combinations thereof. Examples of poly(carboxylic acid)s include poly(acrylic acid) (PAA), poly(methacrylic acid) (PMAA), poly(maleic acid), poly(ethylacrylic acid) (PEAA), poly(propylacrylic acid) (PPAA), poly(4-vinylbenzoic acid) (PVBA), poly(itaconic acid) (PIA), and combinations thereof. Examples of poly(phosphonic acid)s include poly(ethylene glycol acrylate phosphate) (PEGAP), poly(vinylphosphonic acid) (PVPA), poly(ethylene glycol methacrylate phosphate) (PEGMP), poly(4-vinyl-benzyl phosphonic acid) (PVBPA), and combinations thereof. Examples of poly(sulfonic acid)s include sulfonated aromatic polymers, poly(vinylsulfonic acid) (PVSA), poly(4-styrenesulfonic acid) (PSSA), poly(2-acrylamido-2-methylpropane sulfonic acid) (PAMPS), poly(3-sulfopropyl methacrylate) (PSPMA), and combinations thereof. Examples of poly(amino acid)s include poly(aspartic acid) (PASA), poly(L-glutamic acid) (PLGA), poly(histidine) (PHIS), and combinations thereof. Examples of poly(boronic acid)s include poly(vinylphenyl boronic acid) (PVPBA), poly(3-acrylamidophenyl boronic acid) (PAAPBA), and combinations thereof.

Specific examples of acid functional polymers include poly(acrylic acid) (CH₂—CHC(═O)OH)ₙ, where n is the number of repeating units), sulfonated poly(phenylene) (sPP), sulfo-phenylated poly(phenylene) (sPPP), and combinations thereof. In embodiments, the ion-exchange capacity (IEC) of the acid functional polymer, which represents the number of basic groups that can be neutralized by the acid functional polymer, may be greater than or equal to about 2 milliequivalents H⁺per gram (meq H⁺/g), optionally greater than or equal to about 3 meq H⁺/g, or optionally greater than or equal to about 3.7 meq H⁺/g.

The functional polymer may be a homopolymer or a copolymer. In embodiments, the functional polymer may comprise a copolymer including acid functional monomers, as well as monomers without acidic functional groups (unsubstituted monomers). For example, the functional polymer may comprise a copolymer of a sulfonated poly(phenylene) and an unsubstituted poly(phenylene). In some specific examples, the functional polymer may comprise a copolymer of a sulfo-phenylated poly(phenylene) and an unsubstituted phenylated poly(phenylene).

When the acidic functional groups in the acid functional polymer react with the basic compounds (e.g., the OH⁻ anions and the Li⁺ cations) in the precursor mixture, at least some of the acidic functional groups in the acid functional polymer are deprotonated, forming a lithium salt of the acid functional polymers with the concomitant release of water. As such, the functional polymer included in the final negative electrode 22 may or may not include acidic functional groups.

The acidic functional groups in the acid functional polymer are hydrophilic and, in some embodiments, may provide the acid functional polymer with good water solubility. In such case, in some embodiments, deprotonation of the acidic functional groups in the acid functional polymer may result in the formation of a functional polymer that is insoluble in water. Such insoluble functional polymers may deposit on surfaces of the LSO material, thereby creating a physical barrier on the LSO material that can provide the LSO material with long-term protection against undesirable physical and/or chemical interactions with the aqueous solvent in the precursor mixture.

Precursor mixtures prepared without the addition of an acid functional polymer had significant off gassing immediately after mixing and the off gassing continued even after the samples were allowed to age. The addition of the acid functional polymer in the precursor mixture results in the formation of a precursor mixture having a relatively low pH, as compared to that of precursor mixtures that did not include an acid functional polymer. The addition of a water soluble acid functional polymer in the precursor mixture effectively prevents the generation of gas bubbles (e.g., H₂ gas) in the precursor mixture, even after aging for about 24 hours. On the other hand, the addition of an acidic solution (e.g., tannic acid) to precursor mixture (without the addition of an acid functional polymer) was ineffective in preventing or inhibiting the generation of gas bubbles in the precursor mixture, indicating that the acid functional polymer not only neutralizes the pH of the precursor mixture but also protects the LSO material from undesirable reactions with the water in the aqueous solvent.

When sPPP is used as the acid functional polymer in the precursor mixture, gas bubble generation was effectively prevented in the precursor mixture, even after aging for over 72 hours. On the other hand, when PAA was used as the acid functional polymer in the precursor mixture, gas bubble generation occurred after ageing the precursor mixture for greater than about 24 hours. Without intending to be bound by theory, it is believe that the sustained effectiveness of the sPPP in preventing gas bubble generation is due to the insolubility of Li-sPPP in water.

As an acid functional polymer, sPPP is water soluble. However, when at least some of the sulfo functional groups in the sPPP react with lithium ions in the precursor mixture and form a lithium salt of the sulfo-phenylated poly(phenylene) (Li-sPPP), the resulting Li-sPPP is substantially insoluble in water. It is believed that, when the sPPP transitions to Li-sPPP, the Li-sPPP precipitates from the precursor mixture and deposits on surfaces of the LSO material. Because the Li-sPPP is insoluble in the aqueous solvent, the Li-sPPP remains on the surfaces of the LSO material and does not redissolve in the aqueous solvent over time, unlike Li-PAA, which remains soluble in water when lithiated and thus may not remain on the surfaces of the LSO material after the PAA reacts with the basic compounds in the LSO material. In sum, PAA may be included in the precursor mixture to help neutralize the pH of the precursor mixture and help prevent the generation of gas bubbles in the precursor mixture for durations of up to about 24 hours. In addition to neutralizing the pH of the precursor mixture, sPPP may help prevent the generation of gas bubbles in the precursor mixture for durations of greater than about 72 hours.

After the negative electrode 22 is formed on the metal substrate (i.e., the negative electrode current collector 30), the negative electrode 22 may be assembled into the battery 20 and the negative electrode 22, the positive electrode 24, and the separator 26 may be infiltrated with the electrolyte 28. Then, the negative electrode current collector 30 and the positive electrode current collector 32 may be electrically coupled to the power source 34 such that lithium ions are released from the positive electrode 24 and incorporated into the negative electrode 22.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated. Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements).

What is claimed is:

1. A method of manufacturing a negative electrode for a battery that cycles lithium ions, the method comprising:
depositing a precursor mixture on a substrate to form a precursor layer, the precursor mixture comprising an electroactive negative electrode material comprising a lithiated silicon suboxide (LSO) material, a polymer binder, a functional polymer, and an aqueous solvent, the LSO material comprising a basic compound, and the functional polymer comprising an acidic functional group formulated to react with the basic compound in the LSO material to neutralize the pH of the precursor mixture; and
removing the aqueous solvent from the precursor layer to form the negative electrode on the substrate.

2. The method of claim 1, wherein the functional polymer comprises a poly(carboxylic acid), and wherein the acidic functional group comprises a carboxyl functional group (—C(═O)OH).

3. The method of claim 2, wherein the functional polymer comprises poly(acrylic acid).

4. The method of claim 1, wherein the functional polymer comprises a poly(sulfonic acid), and wherein the acidic functional group comprises a sulfo functional group (—S(═O)₂—OH).

5. The method of claim 4, wherein the functional polymer comprises sulfonated poly(phenylene) (sPP), sulfo-phenylated poly(phenylene) (sPPP), or a combination thereof.

6. The method of claim 1, wherein the functional polymer is configured to react with lithium ions in the precursor mixture to form a lithium salt of the functional polymer, wherein the lithium salt of the functional polymer is insoluble in the aqueous solvent, and wherein the lithium salt of the functional polymer is configured to deposit on surfaces of the LSO material to form a physical barrier that prevents chemical reactions from occurring between the LSO material and the aqueous solvent.

7. The method of claim 1, wherein the functional polymer has a molecular weight of greater than or equal to about 10,000 grams per mole and less than or equal to about 400,000 grams per mole.

8. The method of claim 1, wherein the LSO material has a nanoporous structure including open nanopores, and wherein the functional polymer is sized such that the functional polymer can infiltrate the open nanopores of the LSO material.

9. The method of claim 1, wherein the polymer binder comprises styrene butadiene rubber (SBR) and sodium carboxymethyl cellulose (Na-CMC).

10. The method of claim 1, wherein the basic compound comprises lithium hydroxide (LiOH), lithium carbonate (LiCO₃), or a combination thereof.

11. The method of claim 1, wherein the electroactive negative electrode material comprises the LSO material and graphite.

12. The method of claim 1, wherein the precursor mixture further comprises an electrochemically inactive, electrically conductive carbon-based material.

13. The method of claim 1, further comprising:
preparing the precursor mixture by introducing the LSO material into a solution comprising the polymer binder, the functional polymer, and the aqueous solvent.

14. The method of claim 1, further comprising:
preparing the precursor mixture by preparing a first mixture comprising the LSO material and the functional polymer, preparing a second mixture comprising the polymer binder and the aqueous solvent, and then introducing the first mixture into the second mixture.

15. A method of manufacturing a battery that cycles lithium ions, the method comprising:
depositing a precursor mixture on a negative electrode current collector to form a precursor layer, the precursor mixture comprising an electroactive negative electrode material comprising, a polymer binder, a functional polymer comprising a sulfonated poly(phenylene), and an aqueous solvent, the electroactive negative electrode material comprising a lithiated silicon suboxide (LSO) material and optionally graphite, the LSO material comprising a basic compound, and the functional polymer comprising a sulfo functional group (—S(═O)₂—OH) formulated to react with the basic compound in the LSO material to neutralize the pH of the precursor mixture;
removing the aqueous solvent from the precursor layer to form a negative electrode on the negative electrode current collector; and
assembling the negative electrode and the negative electrode current collector into a stack comprising a positive electrode disposed on a positive electrode current collector and a separator sandwiched between opposed facing surfaces of the negative electrode and the positive electrode, the positive electrode comprising lithium ions.

16. The method of claim 15, wherein the functional polymer comprises sulfo-phenylated poly(phenylene) (sPPP).

17. The method of claim 15, wherein the functional polymer is configured to react with lithium ions in the precursor mixture to form a lithium salt of the functional polymer, wherein the lithium salt of the functional polymer is insoluble in the aqueous solvent, and wherein the lithium salt of the functional polymer is configured to deposit on surfaces of the LSO material to form a physical barrier that prevents chemical reactions from occurring between the LSO material and the aqueous solvent.

18. The method of claim 15, wherein the polymer binder comprises styrene butadiene rubber (SBR) and sodium carboxymethyl cellulose (Na-CMC).

19. A battery that cycles lithium ions, the battery comprising:
a negative electrode comprising an electroactive material, a polymer binder, and a functional polymer comprising a lithium salt of a sulfonated poly(phenylene), the electroactive material comprising a lithiated silicon suboxide (LSO) material and optionally graphite;
a positive electrode spaced apart from the negative electrode and comprising an electroactive positive electrode material; and
an electrolyte infiltrating the negative electrode and the positive electrode, the electrolyte comprising a lithium salt in a polar aprotic organic solvent.

20. The battery of claim 19, wherein the functional polymer comprises a lithium salt of a phenylated sulfonated poly(phenylene), and wherein the functional polymer is insoluble in water.
